(19) United States
(12) Patent Application Publication
(10) Pub. No.: US 2016/0071216 A1
(43) Pub. Date: Mar. 10, 2016

(54) SYSTEM FOR AUTOMATED SCHEDULING AND RATING OF INSURANCE CLAIM REVIEWS

(71) Applicant: Hartford Fire Insurance Company, Hartford, CT (US)

(72) Inventor: Jeffery K. Florence, Palmer, MA (US)

(21) Appl. No.: 14/482,868

(22) Filed: Sep. 10, 2014

(51) Int. Cl. G06Q 40/08

(52) U.S. Cl. CPC G06Q 40/08

(57) ABSTRACT

Embodiments provide a system for intelligent scheduling of insurance company file reviews and obtaining feedback on the same. The system may include generating calendar schedules for adjusters and adjusting the calendar schedules automatically based upon schedule conflicts. An additional embodiment may aggregate feedback and provide a quality score. This information may be used in one embodiment to rank the adjusters. Such information may also assist in identifying insurance company personnel who may need remedial work to improve their skills associated with claim file reviews.

### BACKGROUND

In the insurance industry, periodic claim file reviews are typically done. The periodicity may vary depending on a number of factors, including the dollar volume of the premium paid by the client to the insurance carrier, the exposure amount of claims, etc. For example, a large client may want to have annual, semi-annual, quarterly or monthly review of claim files. It may be that the client wants monthly reviews of files with claim exposure over a certain threshold and quarterly reviews of files with claim exposure below the threshold.

A claims file review typically involves the insurance company claims adjusters, who handle the claims, meeting with representatives of the insurance company's client to update the representatives on the status of the claims. It is not unusual for the claims made against an insurance company client to be handled by more than one adjuster, e.g., adjusters may work by insurance lines (property and casualty, aircraft, fire, product liability, malpractice, workers' compensation, etc.) and there may be more than one adjuster handling claims per line. An adjuster may also handle claims against more than one insurance company client.

Care needs to be taken in scheduling insurance company personnel to participate in an insured's claims file review. For example, an insurance company adjuster typically should not be scheduled to participate in claims file reviews for different insureds at the same time. Moreover, it is preferable not to over schedule an adjuster with claim file reviews in any given time period since adjuster preparation is involved for each claim file being reviewed and, from the insured's perspective, lack of adjuster preparation detracts from a quality file review.

### BRIEF SUMMARY

In summary, an embodiment includes a system of scheduling insurance company personnel and providing feedback. In an example embodiment, the system may include preparation of a spreadsheet which may be used as a tool by insurance company management to view the scheduling of insurance company personnel (i.e., for claim file reviews) and also to display insured's feedback on the performance of the insurance company personnel (e.g., timeliness, quality, and presentation). Additional embodiments are described, including other systems, as well as devices/apparatuses, systems including multiple devices, and products.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 is a partially functional block diagram that illustrates aspects of a computer system provided in accordance with some embodiments of the invention.

FIG. 2 is a block diagram that illustrates a personal computer that may be employed as a terminal in the system of FIG. 1.

FIG. 3 illustrates an example system for automated scheduling and rating of insurance claim reviews.

FIG. 4 illustrates an example of the data contained within a database in accordance with an embodiment.

FIG. 5 illustrates an example of a scheduling tool in accordance with an embodiment.

FIG. 6 illustrates an example of a feedback tool in accordance with an embodiment.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

A claim file review (CFR) may consist of a conference call between representatives of the insured and the appropriate insurance company personnel. Thus, representatives of the insured would be on the line and the appropriate insurance company personnel would call into the conference call at a designated time. It should be noted, however, that various other methods of conducting the CFR may be employed, such as in person, voice-over-IP computer based communication, virtual meetings (e.g., WEBEX), etc. The claim file review may be used to review a claim status report. This report may include information including the name of the insured, policy number, and the date that the report was generated. The report may also include additional information, for example, claim information (e.g., employee name, occupation, date of claim, compensation rate, etc.), financial information (e.g., cost of treatment, amount paid, outstanding balance, etc.), coverage demographics (e.g., description of accident, whether the claim is covered, description of injuries, etc.), medical management (e.g., summary of treatment, follow-up treatment, diagnosis, etc.), litigation status (e.g., is the injured litigating, settlement status, etc.), and other such information.

The present invention provides significant technical improvements to insurance claims file review data processing technology including dynamic resource scheduling in addition to the claims file review. The present invention is directed to more than merely a computer implementation of a routine or conventional activity previously known in the industry as it significantly advances the technical efficiency, access and/or accuracy of insurance claims file review data processing by implementing a specific new system as defined herein. The present invention is a specific advancement in the area of insurance claims file review data processing by providing technical benefits in data accuracy, data availability, and data integrity and such advances are not merely a longstanding commercial practice.

The present invention provides improvement beyond a mere generic computer implementation as it involves the processing and conversion of significant amounts of data in a new beneficial manner as well as the interaction of a variety of specialized insurance, client and/or vendor systems, networks and subsystems. For example, in one embodiment of the present invention a spreadsheet file is created to provide a tool for managing the scheduling of insurance company personnel. In a preferred embodiment the spreadsheet contains several worksheets, including a calendar which visually displays various information relating to scheduling, and a CFR Feedback which aggregates feedback information by insurance company personnel (including a quality score). In another example embodiment, the tool uses triggers to suggest the timing of activities relating to the life cycle of a policy. For example, the tool may suggest timing for a consultation, an activity outside an already scheduled service activity, to review files, and the like.

An embodiment may additionally track metric compliance measures, allowing review of an employee. The tool may automatically capture metrics and identifiable and measureable subjective factors relating to an employee. This may reduce the manual capturing and recording that is necessary using traditional employee review methods. The tool may additionally allow a comparison between employees (or performers) and create a ranking of the employees based upon the metrics and factors previously captured. An average ranking may be created including areas which the employee may improve.

Insurance company management may utilize the tool for various purposes, such as scheduling, load balancing, and rating in insurance claims processes. For example, the scheduling information may be reviewed to ensure that neither an adjuster nor their supervisor (e.g., adjuster) is over scheduled for CFRs. Additionally or alternatively, the tool may provide a system for suggesting the timing of activities associated with the life cycle of a policy. Customer feedback from scheduled activities may additionally be used to identify adjusters that are in need of further training on conducting CFRs. Among other things, the tracking of the CFRs and customer feedback may allow an employer or manager to track and rank employees based upon metric compliance measures and subjective factors relating to the employee.

The illustrated example embodiments will be best understood by reference to the figures. The following description is intended only by way of example, and simply illustrates certain example embodiments.

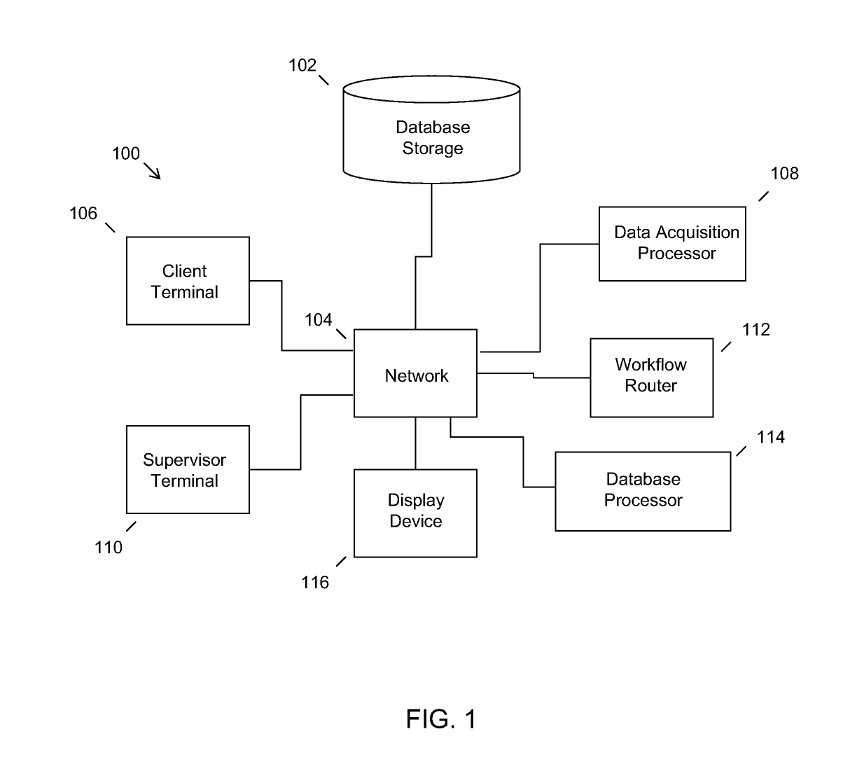

Features of some embodiments of the present invention will now be described by first referring to FIG. 1. FIG. 1 is a partially functional block diagram that illustrates aspects of a computer system 100 provided in accordance with some embodiments of the invention. For present purposes it will be assumed that the computer system 100 is operated by an insurance company (not separately shown) for the purpose of scheduling and receiving feedback on CFRs.

The computer system 100 includes a database storage module 102. In terms of its hardware the data storage module 102 may be conventional, and may be composed, for example, by one or more magnetic hard disk drives. A function performed by the data storage module 102 in the computer system 100 is to receive, store, and provide access to files relating to insurance claims. The claims may be from one or more different lines of insurance, such as worker's compensation, property and casualty, automobile, etc. The data storage module 102 may also store data that reflects responses to the CFR satisfaction surveys that are described below. Still other data may be stored in the data storage module 102, including for example, data that is relevant to the scheduling of CFRs, data that is relevant to employee reviews, and/or data that is relevant to timing of activities related to files. Although the data storage module 102 is depicted as a single device in FIG. 1, in practice its functions may be spread among a number of different devices, such as plural server computers which incorporate their own storage capabilities.

The computer system 100 may also include a data communication network 104 to which the data storage module 102 is coupled. The data communication network 104 may, for example, be conventional in its construction and functionality, and may serve as an “intranet” for the insurance company. In some embodiments the data communication network may also incorporate and/or be connected to a public data communication network (not separately shown) such as the Internet.

The computer system 100 may further include a number of terminals 106 that may be employed by clients (e.g., customers) of the insurance company, for example, to provide feedback on insurance company personnel who participate in CFRs. As will be seen, the terminals 106 (hereinafter referred to as “client terminals”), may be constituted by conventional personal computers coupled to the data communication network 104. One function that may be performed by the client terminals 106 is to input data indicative of the performance of insurance company personnel in CFRs.

In addition, the computer system 100 may include a data acquisition processor 108 that is also coupled to the data communication network 104. The data acquisition processor 108 may be constituted by one or more conventional microprocessors included in one or more server computers (not separately shown in FIG. 1) that may be programmed to function in accordance with the present invention. The data acquisition processor 108 may function to receive the client feedback response data from the client terminals 106 (via the data communication network 104) and to store the client feedback response data in the database storage module 102. The data acquisition processor may also classify the client feedback responses as to whether the responses are marginal, standard, or does not meet expectations (e.g., unsatisfactory). (In some embodiments, the responses may be at least partially so classified at the client terminals 106, in which case the data acquisition processor 108 may be deemed to at least partially overlap with the client terminals 106.)

Still further, the computer system 100 may include a number of terminals 110 operated by supervisory employees of the insurance company. Like the client terminals 106, the terminals 110 (hereinafter referred to as “supervisor terminals”) may be constituted by conventional personal computers coupled to the data communication network 104. The supervisory employees who operate the supervisor terminals 110 may be charged with supervising adjusters whose claim files are stored in the data storage module 102.

Moreover, the computer system 100 may include a workflow router 112 that is coupled to the data communication network 104 and thus is in communication, at least from time to time, with the data acquisition processor 108. The workflow router 112 may be constituted by one or more conventional microprocessors that may for example be included in one or more conventional server computers (not separately shown in FIG. 1). For example, the workflow router 112 may at least partially overlap with the data acquisition processor 108. The workflow router may operate to route, to the supervisor terminals 110, claim files determined, from CFR satisfaction surveys, to be in need of remedial attention to achieve client satisfaction. In some embodiments, the workflow router may also operate to capture and record actions taken by supervisors in response to the messages to them that indicate a need for remedial attention.

The computer system 100 may also include a database processor 114 that is coupled to the data communication network 104, and thus is in communication, at least from time to time, with the database storage module 104. The database processor may be constituted by one or more conventional microprocessors that may for example be included in one or more conventional server computers (not separately shown in FIG. 1) that may be programmed to function in accordance with the present invention. For example, the database processor 114 may at least partially overlap with the data acquisition processor 108. The database processor 114 may operate to identify and report trends in client feedback response data stored in the database storage module 104 by the data acquisition processor 108.

Still further, the computer system 100 may include a display device 116 that is coupled to the data communication network 104. Accordingly, the display device 116 may be in communication, at least from time to time, with the database processor 114. As will be appreciated from subsequent discussion, the display device 116 may be employed to provide one or more screen displays concerning responses to CFR surveys, including summaries, trends and/or aggregations of client feedback response data.

As will be understood from subsequent discussion, the data acquisition processor 108 (possibly in conjunction with one or more other components of the computer system 100) may operate to selectively classify feedback responses to the CFR survey as “marginal,” “standard,” or “does not meet”. “Marginal” and “does not meet” evidence a need for improvement in the performance of the adjusters who are handling claims for the insurance company that operates the computer system 100. In response to such a classification of a customer feedback response, the database processor may operate to identify and report trends in client feedback response data stored in the database storage module 104 by the data acquisition processor 108. The workflow router 112 may operate to route the client feedback response data to the supervisor terminal 110. The supervisor terminal may be operated by a supervisor of adjusters or other employee of the insurance company or of an affiliate of the insurance company, such as another company affiliated with the insurance company that operates the computer system 100.

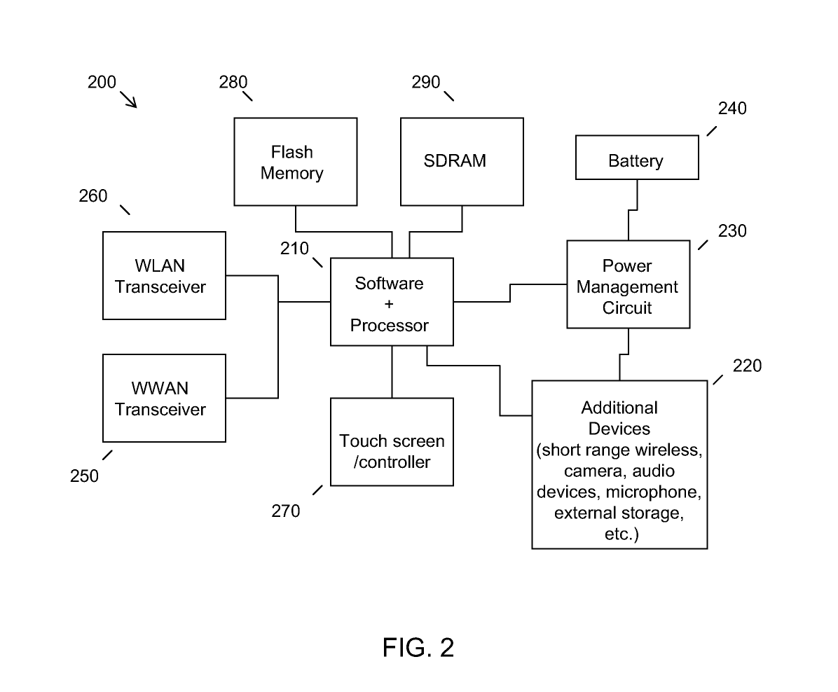

FIG. 2 is a block diagram that illustrates a typical one of the client terminals 106 shown in FIG. 1. In its hardware aspects, the client terminal 106 may be entirely conventional, but may be programmed and/or may download interactive webpages so as to function in accordance with aspects of the present invention.

While various other circuits, circuitry or components may be utilized in information handling devices, an example illustrated in FIG. 2 includes a system design found for example in tablet or other mobile computing platforms. Software and processor(s) are combined in a single unit 210. Internal busses and the like depend on different vendors, but essentially all the peripheral devices (220) may attach to a single unit 210. The circuitry 200 combines the processor, memory control, and I/O controller hub all into a single unit 210. Also, systems 200 of this type do not typically use SATA or PCI or LPC. Common interfaces for example include SDIO and I2C.

There are power management circuits(s) 230, e.g., a battery management unit, BMU, which manage power as supplied for example via a rechargeable battery 240, which may be recharged by a connection to a power source (not shown). In at least one design, a single unit, such as 210, is used to supply BIOS like functionality and DRAM memory.

System 200 typically includes one or more of a WWAN transceiver 250 and a WLAN transceiver 260 for connecting to various networks, such as telecommunications networks and wireless Internet devices, e.g., access points. Additional devices 220 are commonly included. Commonly, system 200 will include a touch screen/controller 270 for data input and display. System 200 also typically includes various memory devices, for example flash memory 280 and SDRAM 290.

Information handling device circuitry, as for example outlined in FIG. 2, may be used in devices that are used to submit data to an insurance company. Circuitry such as that outlined in FIG. 2 may also be used by an insurance company that receives data submissions, e.g., for processing the data submissions into categories, calculation of other parameters of interest, and communicating instructions regarding the same.

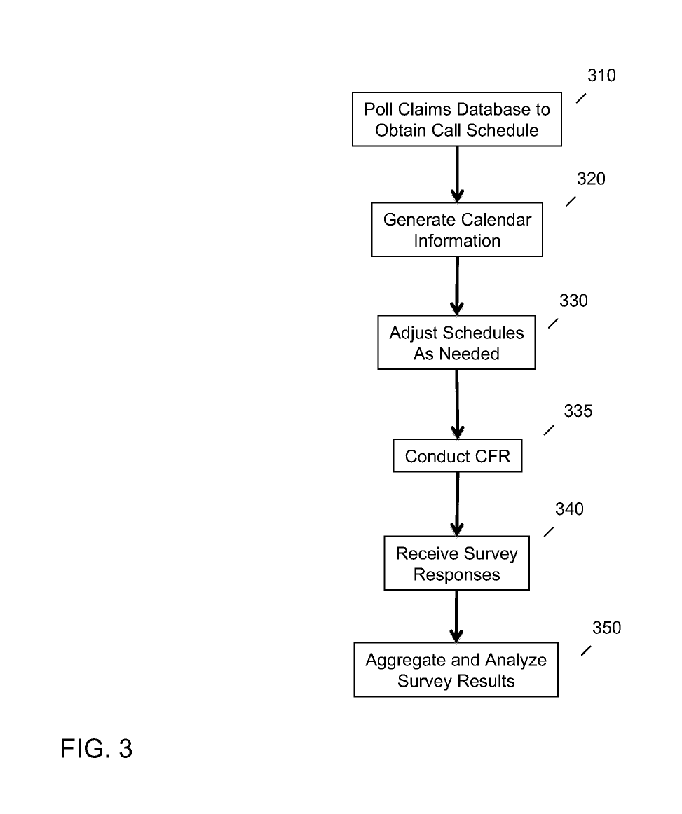

In FIG. 3 an example system of providing scheduling information and feedback for claim file reviews is illustrated. As shown, at 310 a claims database is polled to obtain information relating to scheduled calls during which claim file reviews will occur. This polling may occur when a claims service consultant (CSC) runs a list of open files for a particular account. At step 320 the information obtained from the claims file database is used to generate calendar information, as discussed below. At step 330 schedules of the participants in the claim file reviews are adjusted as needed. Adjustments may be made to ensure that an adjuster or other participant has a reasonable number of calls on any given day, or the calls are not otherwise bunched (i.e., overscheduling of the participants). At step 335 the claim file review is conducted. At step 340 survey responses related to the CFR are received. The survey may have multiple survey sections regarding different aspects of the review and consultant. For example, the survey may include sections regarding the timeliness, quality, presentation, and the like of the review and/or the consultant(s). At step 350, the survey results are aggregated and analyzed. Such aggregation and analysis may include the generating of a survey report.

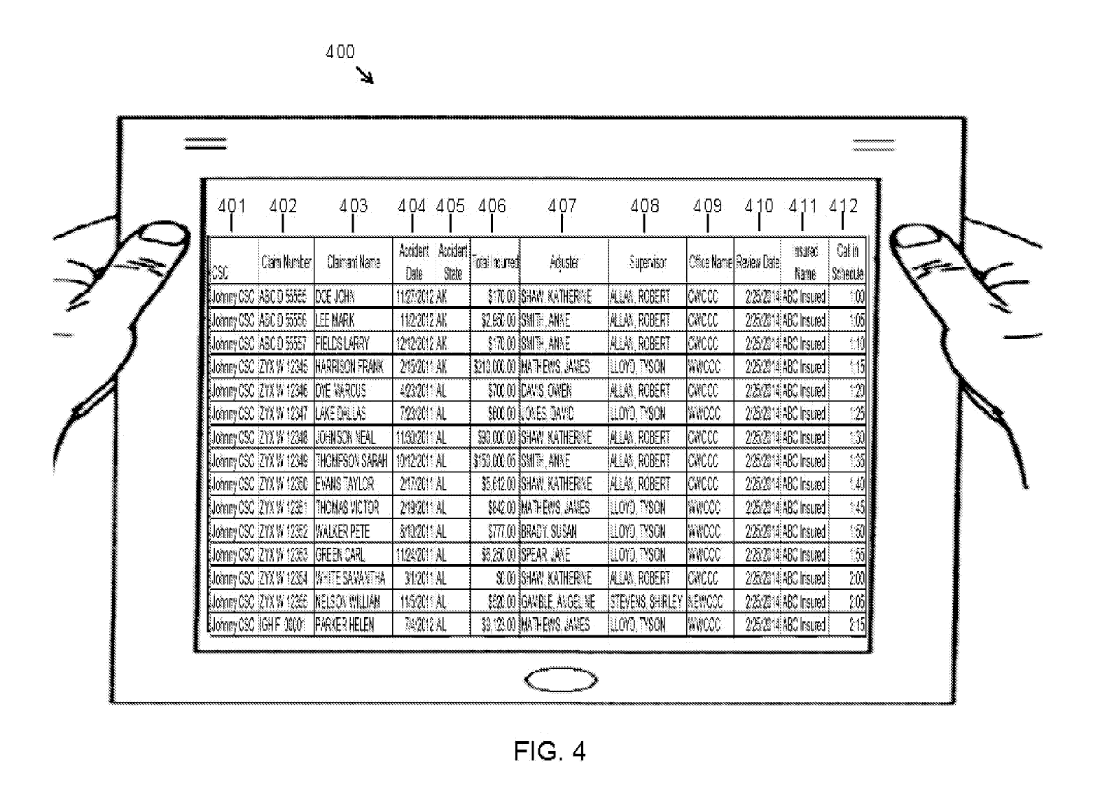

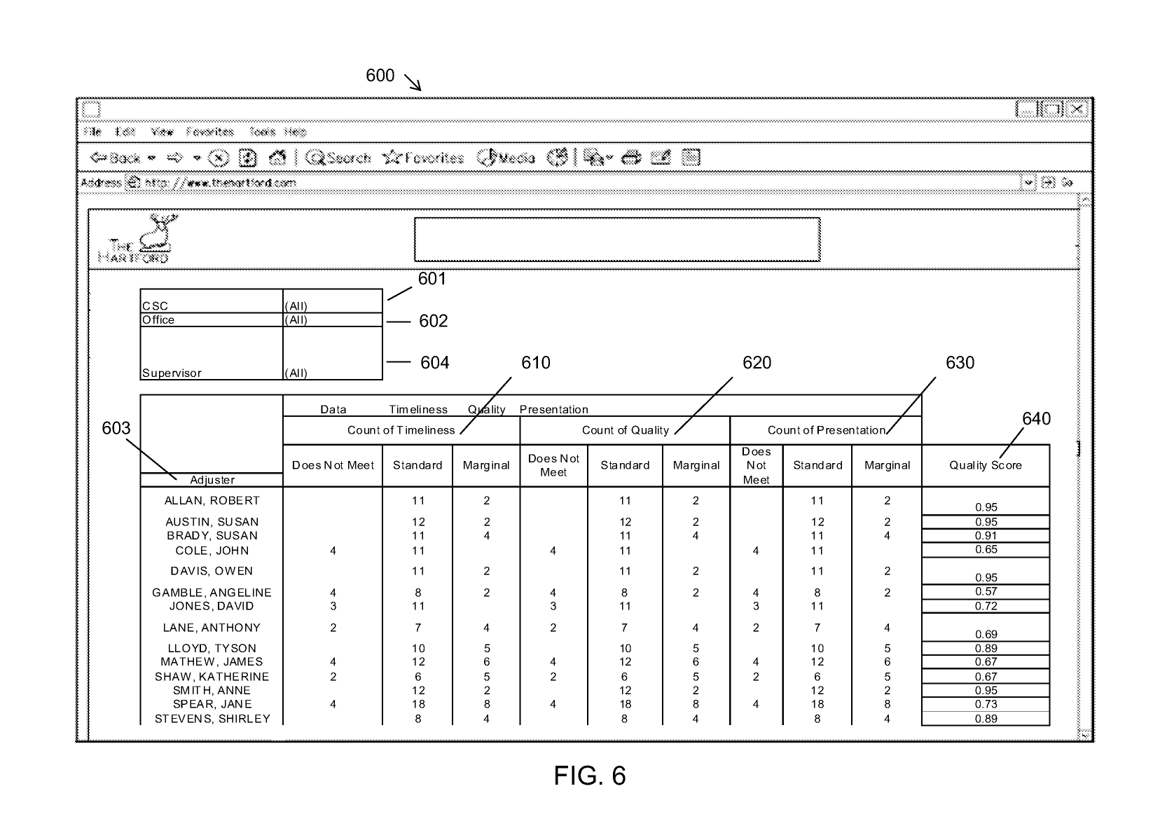

FIG. 4 illustrates the contents of a claims file database after it has been populated with the survey results. As shown, the information in the database includes the following: client service center (CSC) 401, claim number 402, claimant name 403, accident date 404 (e.g., date of insured event), accident state 405 (e.g., state in which insured event occurred), total involved 406 (e.g., claim amount), adjuster handling claim 407, adjuster's supervisor 408, insurance company office in which adjuster is located 409, date of claim file review 410, name of insured 411, and call in schedule 412 (e.g., time of claim file review). Additional information may be included within the database. For example, the information may additionally include information relating to the insured's feedback on the claim file review (e.g., timeliness, quality, and presentation, and overall comments), as shown in FIG. 6. Comments on timeliness, quality, and presentation may be limited to standard, marginal, and does not meet expectations. Additional identifications of quality, however, may be used.

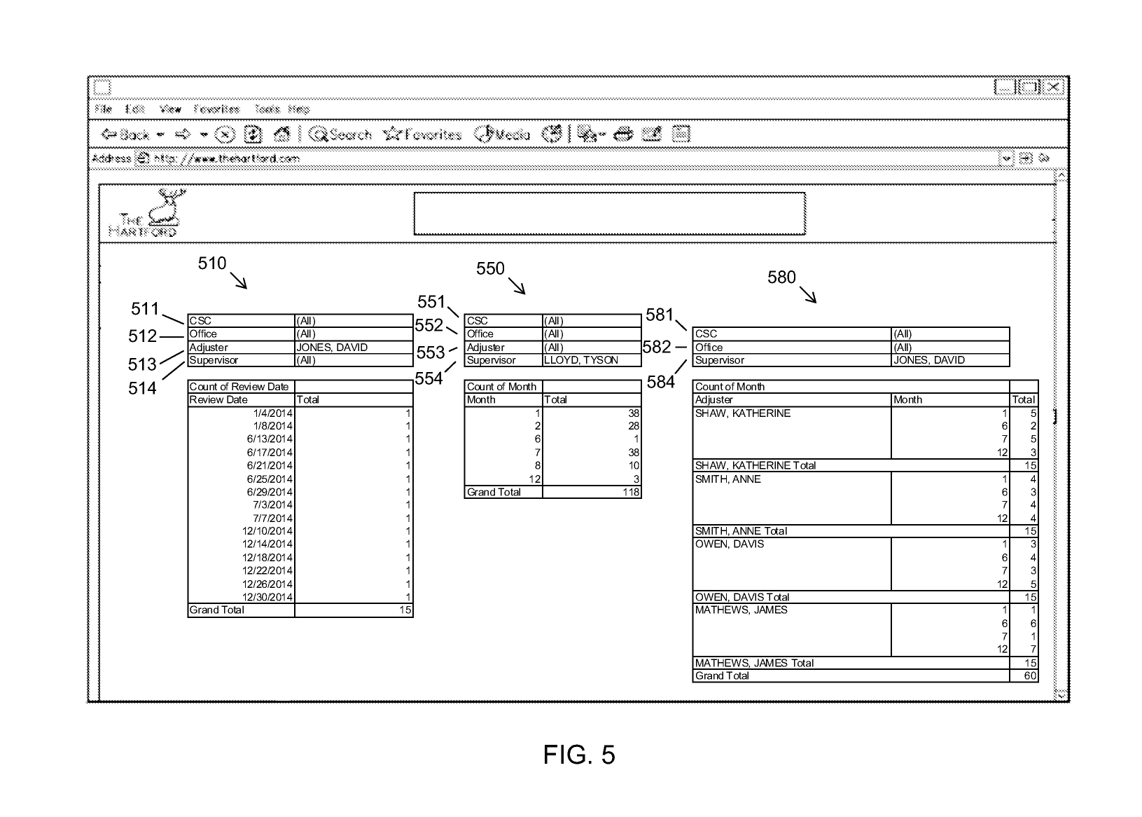

FIG. 5 is an example of calendar information that may be generated in step 320 of FIG. 3. At 510, the claim file review calls are shown for a particular adjuster (identified at 513). The client review calls are shown by date for a specified time period (in this case, 2014). It should be noted that this information is preferably displayed in spreadsheet form, such as MICROSOFT EXCEL, although any suitable spreadsheet may be used. As such, items 511-514 are user selectable (e.g., through the use of a drop down menu). For example, any relevant client service center (CSC), insurance company office, adjuster, or supervisor may be selected. As shown, only the adjuster is specified.

At 550, the claim file review calls are shown for a particular supervisor (identified at 554). Again, items 551-554 are user selectable. As shown, however, only the supervisor is shown. Also shown is the month of the year (e.g., 1=January, 2=February, etc.) and the number of calls scheduled in that month for which the supervisor has supervisory responsibility. Adjuster information, however, is not shown.

At 580, the claim file reviews are shown for a particular supervisor (identified at 584). Again, items 581-584 are user selectable. The information displayed at 580 differs from the information displayed at 550 in that the names of the adjusters for which the supervisor is responsible (and who will be participating in the claim file review calls) is also displayed. As shown, the claim file reviews are shown for a calendar year (e.g., 2014).

In addition to generating a calendar of schedules, one embodiment may also generate suggested timing of activities relating to a particular file, using logic based trigger points. For example, an embodiment may suggest timing of stewardship activities (provide consultative claim expertise relative to an account's experience leveraging reporting and other tools), off-cycle activities (e.g., proactive touch points outside of already scheduled service activities), file reviews, and the like. An embodiment may recommend an action (e.g., recommending new services, file review, client contact, etc.) based upon different factors, for example, time of year, timing of claims, new contact, and the like. Additionally, an embodiment, allows insurance company personnel (e.g., adjuster) to view the entire list of accounts under service to ensure all deliverables are monitored.

FIG. 6 illustrates an example of survey report information that may be generated in step 350 of FIG. 3 as a result of survey results being aggregated and analyzed. 600 represents the report itself. Items 601-604 again are user selectable. At 603 the adjusters (e.g., participants is the file review calls being reviewed by the insureds) are shown. Three attributes of the adjuster's performance in the claims file review call are preferably reviewed (e.g., timeliness 610, quality 620, and presentation 630) although any number of attributes may be reviewed. As shown, the review comments are “does not meet”, “standard”, and “marginal”. It would be possible, however, to use other review comments (e.g., below expectations, meets expectation, exceeds expectations, or similar). The review comments are aggregated to determine a quality score (640). The quality score may be used to identify adjusters who need remedial work on their skills in handling claim file reviews. As shown, the information in FIG. 6 is presented by adjuster name in alphabetical order. In one embodiment, it may be presented in order of quality score (either in descending or ascending order). This assists the appropriate insurance company personnel in identifying those adjusters who need remedial work.

One embodiment may use the quality score to assist in reviewing an employee. For example, an embodiment may automatically capture metric compliance measures in addition to identified and measurable subjective factors, such as those shown in FIG. 6, to determine an employee's ability to meet and/or exceed performance measures. In addition to those factors shown in FIG. 6, other factors and measures may be included in the tool to measure an employee's performance. Some factors and measures may be automatically updated in one embodiment, while others may be manually inputted.

In addition, one embodiment may, after the metric compliance measures and factors are captured, rank each employee (or performer) by category and measures. The ranking may then be compared against other performers with the same objective or the ranking may be compared across a group of performers such as a team. The team may all have the same objectives allowing a direct comparison of team members or the team may have different objectives. An embodiment may then roll up the combined averages to produce an average rank, which may then produce a final ranking. For example, one team member may be ranked highest against all other team members based upon individual categories and factors. One embodiment may additionally provide a method for identifying areas of improvement. For example, if one performer is ranked low in one category an embodiment may disclose this category as an area for improvement.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device readable storage medium(s) may be utilized. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage medium is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example systems, devices and program products according to various example embodiments. It will be understood that the actions and functionality may be implemented at least in part by program instructions. These program instructions may be provided to a processor of an information handling device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A system for dynamic load balancing and performance rating using real time schedule and feedback data, comprising:
a database;
a network interface;
a processor operatively connected to the database and the network interface; and
a memory that stores instructions executable by the processor to:
poll, using a processor, a claims database to obtain information relating to schedules of insurance claim file reviews;
generate, using a processor, a calendar schedule for at least one adjuster using the information;
wherein to generate a calendar schedule comprises receiving a trigger regarding at least one future activity and scheduling an action related to the insurance claim file based upon the trigger;
adjust, using a processor, the calendar schedule automatically based upon schedule conflicts;
receive, over a network connection facilitated by the network interface, in response to a claims file review, at least one survey response wherein the at least one survey response include responses regarding attributes of at least timeliness, presentation, and quality;
calculate, using a processor, a rating score based on two out of the three attributes; and
display the rating score in a rating graphical user interface.

2. The system of claim 1, further comprising to:
generate, using a processor, a survey report including the at least one survey response.

3. The system of claim 1, further comprising to:
capture metric compliance measures; and
rank adjusters based upon the metric compliance measures and the at least one survey response.

4. The system of claim 1, further comprising to suggest improvement areas for an adjuster based upon poor survey responses regarding the attributes of at least timeliness, presentation, and quality.

5. A system providing dynamic scheduling and rating, comprising:
a database;
a network interface;
a processor operatively connected to the database and the network interface; and
a memory that stores instructions executable by the processor to:
poll, using a processor, a claims database to obtain information relating to schedules of insurance claim file reviews;
generate, using a processor, a calendar schedule for at least one adjuster using the information;
adjust, using a processor, the calendar schedule automatically based upon schedule conflicts;
wherein the schedule conflicts include at least in part overscheduling of the at least one adjuster;
receive, over a network connection facilitated by the network interface, in response to a claims file review, at least one survey response, wherein the at least one survey response include responses regarding a plurality of attributes; and
calculate, using a processor, a rating score based on the attributes.

6. The system of claim 5, wherein the calendar schedule comprise at least in part conference call appointments.

7. The system of claim 6, wherein to adjust the calendar schedule includes at least in part rescheduling the conference call appointments.

8. The system of claim 5, further comprising to:
generate, using a processor, a survey report including the at least one survey response.

9. The system of claim 8, further comprising to:
capture metric compliance measures; and
rank adjusters based upon the metric compliance measures and the at least one survey response.

10. The system of claim 8, further comprising to suggest improvement areas for the at least one adjuster based upon a poor survey response regarding at least one attribute.

11. The system of claim 8, wherein the survey report comprises user modifiable selection points allowing a user to perform an action selected from the group consisting of: filtering and sorting.

12. The system of claim 5, wherein the schedules include at least in part information regarding timing of at least one future activity associated with an insurance claim file.

13. The system of claim 12, further comprising to:
receive a trigger regarding the at least one future activity; and
recommend an action related to the insurance claim file based upon the trigger.

14. A computerized method of providing scheduling and feedback for claims related data, comprising:
polling, using a processor, a claims database to obtain information relating to schedules of insurance claim file reviews;
generating, using a processor, a calendar schedule for at least one adjuster using the information;
adjusting, using a processor, the calendar schedule automatically based upon schedule conflicts;
wherein the schedule conflicts include at least in part overscheduling of the at least one adjuster;
receiving, over a network connection facilitated by the network interface, in response to a claims file review, at least one survey response, wherein the at least one survey response include responses regarding a plurality of attributes; and
calculating, using a processor, a rating score based on the attributes.

15. The method of claim 14, wherein the calendar schedule comprise at least in part conference call appointments and wherein to adjust the calendar schedule includes at least in part rescheduling the conference call appointments.

16. The method of claim 14, further comprising:
generating, using a processor, a survey report including the at least one survey response.

17. The method of claim 16, further comprising:
capturing metric compliance measures; and
ranking adjusters based upon the metric compliance measures and the at least one survey response.

18. The method of claim 14, wherein the schedules include at least in part information regarding timing of at least one future activity associated with an insurance claim file.

19. The method of claim 18, further comprising:
receiving a trigger regarding the at least one future activity; and
recommending an action related to the insurance claim file based upon the trigger.

20. The method of claim 14, further comprising:
displaying the calendar schedule on a display device.

21. A system providing scheduling and feedback for insurance employees, comprising:
an insurance carrier device, comprising:
a database;
a network interface;
a processor operatively connected to the database and the network interface; and
a memory device that stores instructions executable by the processor to:
poll, using a processor, a claims database to obtain information relating to schedules of insurance claim file reviews;
generate, using a processor, a calendar schedule for at least one adjuster using the information;
adjust, using a processor, the calendar schedule automatically based upon schedule conflicts;
wherein the schedule conflicts include at least in part overscheduling of the at least one adjuster;
receive, over a network connection facilitated by the network interface, in response to a claims file review, at least one survey response, wherein the at least one survey response includes responses regarding a plurality of attributes; and
calculate, using a processor, a rating score based on the attributes.

22. The system of claim 21, wherein the instructions are further executable to generate a survey report including the at least one survey response.

23. The system of claim 21, wherein the instructions are further executable to:
capture metric compliance measures; and
rank adjusters based upon the metric compliance measures and the at least one survey response.

24. The system of claim 21, wherein the schedules include at least in part information regarding timing of at least one future activity associated with an insurance claim file.

25. The system of claim 24, wherein the instructions are further executable to:
receive a trigger regarding the at least one future activity; and
recommend an action related to the insurance claim file based upon the trigger.

26. A product which provides scheduling for insurance employees, comprising:
a storage device having code stored therewith, the code being executable by a processor and comprising:
code that polls a claims database to obtain information relating to schedules of insurance claim file reviews;
code that generates a calendar schedule for at least one adjuster using the information;
code that adjusts the calendar schedule automatically based upon schedule conflicts;
wherein the schedule conflicts include at least in part overscheduling of the at least one adjuster;
code that receives, over a network connection facilitated by the network interface, in response to a claims file review, at least one survey response, wherein the at least one survey response include responses regarding a plurality of attributes; and
code that calculates a rating score based on the attributes.
